(19) United States
(12) Patent Application Publication
(10) Pub. No.: US 2015/0087318 A1
(43) Pub. Date: Mar. 26, 2015

(54) DUAL-PROTOCOL FEMTOCELL-LESS COMMUNICATIONS

(71) Applicant: Femto Access Ltd., Road Town, Tortola (VG)

(72) Inventors: Tuvia Apelewicz, Ra'anana (IL); Zohar Zeev Barzilai, Tel Aviv (IL)

(73) Assignee: Femto Access Ltd., Road Town, Tortola (VG)

(21) Appl. No.: 14/386,116

(22) PCT Filed: Mar. 20, 2013
(86) PCT No.: PCT/IL2013/050268

§ 371 Date: Sep. 18, 2014

Related U.S. Application Data
(60) Provisional application No. 61/612,984, filed on Mar. 20, 2012.

(51) Int. Cl. H04L 12/781; H04W 40/02

(52) U.S. Cl. CPC H04L 45/52; H04W 40/02
USPC 455/445

(57) ABSTRACT

Systems and method are provided herein which enable dual-protocol femtocell-less communications. A communication router is arranged to communicate with one or more user equipment (UEs) over a non-cellular protocol and further communicate via a communication link with a cellular communication network operating in a cellular communication protocol. The UEs or the communication router comprise a femtoless client module which mediates non-cellular communication between the UEs and the celellular network. The UEs are arranged to communicate with base stations connected to the cellular communication network both over the cellular communication protocol as well as over the non-cellular communication protocol via the communication router. The UEs are configured to switch between non-cellular and cellular communication, based on predefined criteria. In the former case, cellular air interface is avoided.

### BACKGROUND

The present invention relates to the field of communication, and more particularly, to dual protocol communication.

The evolution of cellular networks is towards higher data capacity and hence advanced and high speed multimedia applications, especially in the indoor environment.

Today Global System for Mobile Communications (GSM) and 3G Wideband Code Division Multiple Access (WCDMA) network deployment in capacity mode is such that the average distance between adjacent base stations is 500 to 800 meters in dense urban environment. High Speed Packet Access (HSPA), Long Term Evolution (LTE) deployment and 4G and 5G technologies require much denser topology of base stations. This requirement is hard to fulfill because of regulation constraints, site acquisition limitations, and excessive costs.

A solution 70 to the indoor coverage of high capacity cellular deployment for user equipment (UE) 80 is the Home Node B (HNB), also known as femtocell 85. Femtocell 85 is a cellular access point containing a single sector radio base station and the associated Radio Node Controller (RNC) functionality. Femtocell 85 connects to the cellular operator's network 90 via the public internet connectivity available in the indoor. This interface is called the Iuh interface, and it is terminated in Iuh aggregator component 91 in the operator's facility as shown in FIG. 1A which illustrates the femtocell solution of the prior art.

The 3rd Generation Partnership Project (3GPP), which is the standard body for Global System for Mobile Communications (GSM), WCDMA, LTE cellular Technologies and 4G/5G technologies, has set the Femto architecture to include base station as well as RNC functionalities. This architecture does not enable soft handoff capabilities, and as such Femto stations, which are co-sited and are operating on the same carrier frequency, may interfere with each other.

To mitigate interference between the mobile cellular network and the deployed Femto stations, the Femto stations deployment needs to be allocated frequencies other than those used by the cellular network.

A major business case, from the cellular operator's respective, is to be able to offload capacity, also called hand-in process, from the cellular network to the Femto network. This is a hard to implement since there is no communication channel between the cellular RNC and the Femto RNC. As long as there is cellular coverage, the phone will not search for the Femto network. Hence, no hand-in process. It has been proposed to modify the phone architecture so as to make hand-in possible. The means and ways of this architecture change are not yet known.

### BRIEF SUMMARY

Embodiments of the present invention provides a system that includes (i) a communication router arranged to communicate with one or more user equipments (UEs) over a non-cellular protocol and further communicate via a communication link with a cellular communication network operating in a cellular communication protocol; and (ii) one or more UEs arranged to communicate with: one or more cellular base stations connected to the cellular communication network over the cellular communication protocol; and the communication router over the non-cellular protocol, wherein the. UEs are configured to switch between cellular and non-cellular communication protocols, based on predefined criteria.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1B and 1C are high level schematic block diagrams of communication systems according to some embodiments of the invention;

FIG. 2 is a high level schematic illustration of a communication system, according to some embodiments of the invention;

FIGS. 3A-3D are high level schematic illustration of operation states of the system, according to some embodiments of the invention;

FIG. 4A is a high level illustration of the client HNB registration process, according to some embodiments of the invention;

FIG. 4B is a high level illustration of the client HNB registration process, according to some embodiments of the invention;

FIG. 4C is a high level illustration of the connect state's hand-in mobility, according to some embodiments of the invention;

FIG. 4D is a high level illustration of the operation of the client HNB, according to some embodiments of the invention; and

FIG. 5 is a high level schematic flowchart of a method, according to some embodiments of the invention.

It will be appreciated that for simplicity and clarity of illustration,, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Prior to setting forth the detailed description, it may be helpful to set forth definitions of certain terms that will be used hereinafter.

The term “cellular protocol” as used herein in this application refers to any communication protocol which is used in cellular communications such as 3GPP, 3GPP2 and any other protocol used in 3G/4G/5G communications.

The term “non-cellular protocol” as used herein in this application refers to any communication protocol which is not a cellular protocol, for example, an IEEE802.11xx protocol for WiFi communication, an internet protocol, a Bluetooth protocol etc.

The term “femtoless client module” as used herein in this application refers to a communication management software module that is configured to manage communication of user equipment (UE) to a cellular network via at least one cellular protocol and via at least one non-cellular protocol.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

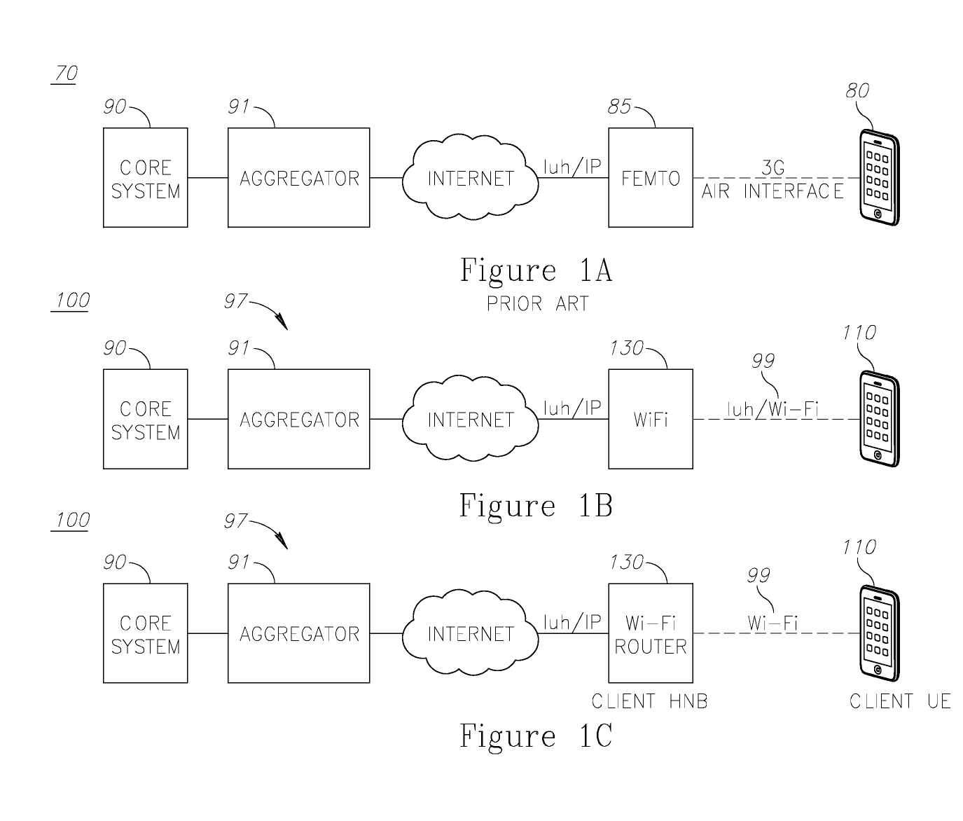

FIGS. 1B and 1C are high level schematic block diagrams of communication systems according to some embodiments of the invention. Systems 100 implement optional communication that avoids cellular air interface for achieving the benefit of interference reduction.

An alternative system 100 to the femtocell solution (FIG. 1A), as well as to future telephone architecture changes, is suggested so as to overcome the above mentioned problems. It is proposed to incorporate an Iuh, by way of a 3G example, client program within the Mobile Station (MS) or the User Equipment (UE), such as a wireless telephone, so that when any broadband, such as cable or Bluetooth or Wi-Fi 99, is available, UE 110 may communicate with aggregator 91 using Iuh protocol over IP over the broadband. As an example Wi-Fi connectivity via router 130 is shown in FIG. 1B. An application program, in UE 110, may govern the information exchange between UE 110 and cellular core 90 that includes Iuh aggregator component 91, over broadband connection 97. That application program is also referred to as client HNB.

In cases in which it may be desired to incorporate the client HNB within broadband router 130, another application program, or client UE, may be required in UE 110. An example showing WiFi 99 as the broadband connectivity of choice is shown in FIG. 1C.

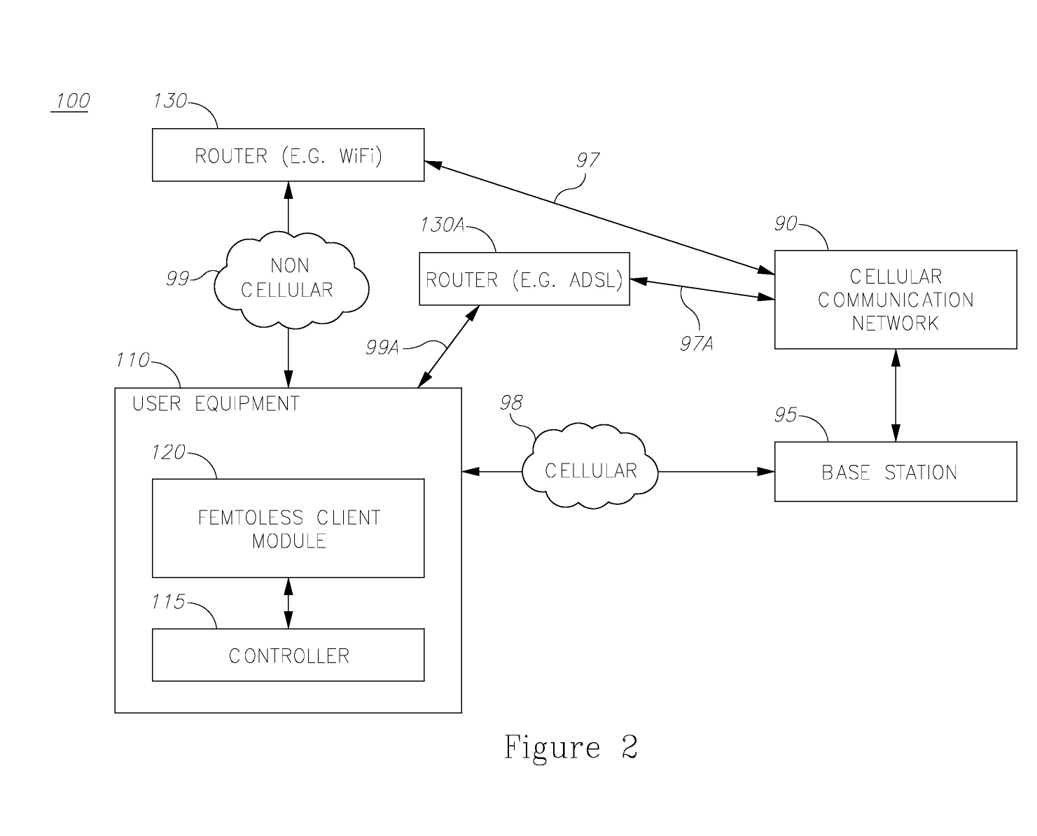

FIG. 2 is a high level schematic illustration of a communication system 100, according to some embodiments of the invention.

System 100 comprises a communication router 130 arranged to communicate with one or more user equipment (UEs) 110 over a non-cellular protocol and further communicate via a communication link 97 with a cellular communication network 90 operating in a cellular communication protocol (e.g. 3GPP/3GPP2).

System 100 further comprises one or more UEs 110 comprising a femtoless client module 120, arranged to communicate with one or more cellular base stations 95 connected to cellular communication network 90 over the cellular communication protocol of communication link 98. UEs 110 are further arranged to communicate with communication router 130 over the non-cellular protocol of communication link 99. Femtoless client module 120 may be controlled by a controller 115 according to conditions and costs of communications. UEs 110 are configured to switch between non-cellular communication (communication links 99 and 97 via router 130) and cellular communication (communication link 98), based on predefined criteria. In particular, using the non-cellular protocols enables an implementation of system 100 that avoids cellular air interface.

Femtoless client module 120 may comprise a communication management software module that is configured to manage communication of user equipment (UE 110) to a cellular network 90 via at least one cellular protocol (any communication protocol which is used in cellular communications) and via at least one non-cellular protocol (any communication protocol which is not a cellular protocol). Femtoless client module 120 may communicate with cellular network 90 over a similar communication link to the one used by a femtocell router, e.g. Iuh/IP as illustrated in FIGS. 1A-1C.

For example, communication link 99 may be wireless (e.g. WiFi, Bluetooth or other) or by wire 99A (e.g. to an internet router such as a cable modem, e.g. ADSL). Router 130 may accordingly communicate with UE 110 wirelessly 99 or over wire 99A, in the latter case router 130 is embodied as a wired router 130A. Communication of router 130, 130A with cellular communication network 90 may be carried out over corresponding communication links 97, 97A, which may be wired or wireless.

In some embodiments, femtoless client module 120 may be implemented outside UE 110, e.g. in a thin client HNB 130 (FIG. 1C) or in a thin Femtocell router that communicates with UE 110 over a non-cellular protocol (e.g. an IEEE802.11xx protocol) and serves merely as an interface between UE 110 and network 90.

UE's 110 may be further arranged to detect communication loss in one of the non-cellular and the cellular protocols and switch communication to the other of the non-cellular and the cellular protocols, as described below.

System 100 may be arranged to provide communication to UE's 110 via an available communication route using at least one of the non-cellular and the cellular protocols, as described below.

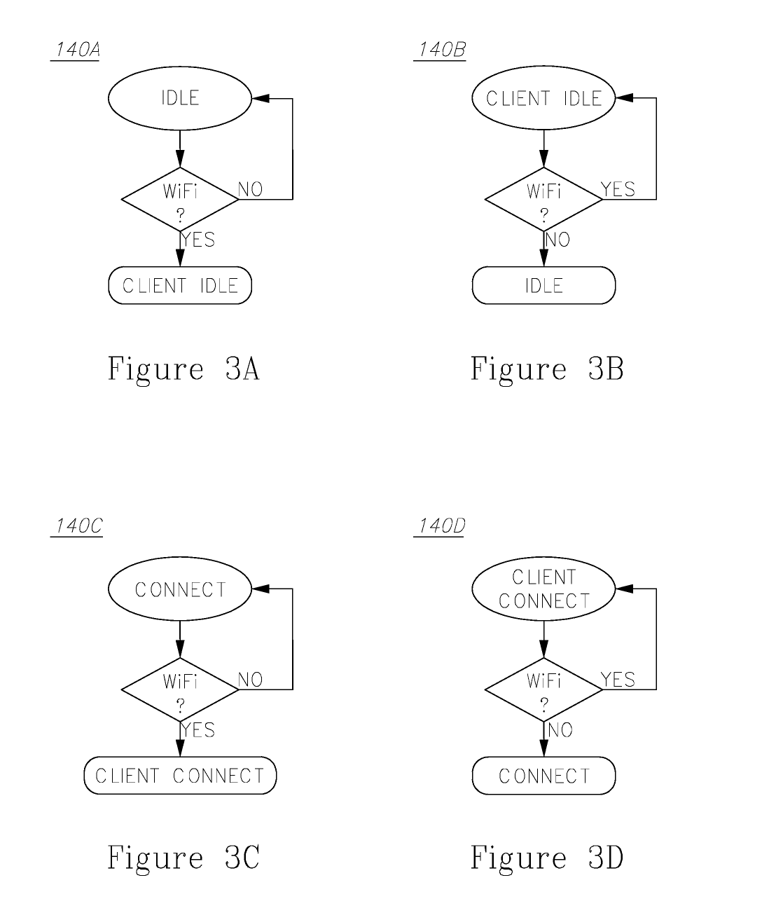

FIGS. 3A-3D are high level schematic illustration of operation states of system 100, according to some embodiments of the invention. FIGS. 3A-3D illustrate the operation states using a WiFi access point 130 as a non-limiting example for router 130. Similar implementation may be carried out using other embodiments of router 130.

FIG. 3A illustrates an idle state 140A in which, when UE 110 is camped on base station 95 (e.g. a 3G/LTE macro) and is idle, i.e. not in connect mode, and WiFi access point 130 is detected, controller 115 such as the client HNB establishes client HNB registration followed by UE registration, and camps on WiFi 130. Femtoless client module 120 interfaces between non-cellular and cellular protocols.

FIG. 3B illustrates a client idle state 140B in which, when UE 110 is camped on WiFi access point 130 and is idle, i.e. not in connect mode, and the WiFi signal is lost, controller 115 e.g. the client HNB may reestablish UE registration on base station 95 e.g. the 3G macro, and camps thereon (e.g. on the 3G/LTE macro).

FIG. 3C illustrates a connect state 140C in which, when UE 110 is camped on base station 95 e.g. a 3G/LTE macro and is connected, i.e. data transfer is in progress, and WiFi access point 130 (as an example for router 130) is detected, controller 115 e.g. the client HNB may establish client HNB registration followed by UE registration, and follows the connected mode hand in mobility procedure described below, over WiFi channel 99. Femtoless client module 120 communicates with cellular network 90 over non-cellular protocols.

FIG. 3D illustrates a client HNB connect state 140D in which, when UE 110 is camped on WiFi access point 130 and is connected, i.e. data transfer is in progress, and the WiFi signal is lost, controller 115 e.g. the client HNB may reestablish UE registration over 3G/4G communication link 98 e.g. the 3G/LTE macro network, and follows the cell relocation procedure as specified e.g. by the 3GPP standard. Femtoless client module 120 may use non-cellular protocols to communicate cellular communication from UE 110. The client performs all of the functions required by the 3GPP standard such as: Client HNB registration, UE registration, connected mode hand-in mobility, connected mode hand-out mobility, Q&M for client HNB, as well as data and circuit switch data transfer.

Steps of the above described states 140A-140D are illustrates in the following diagrams.

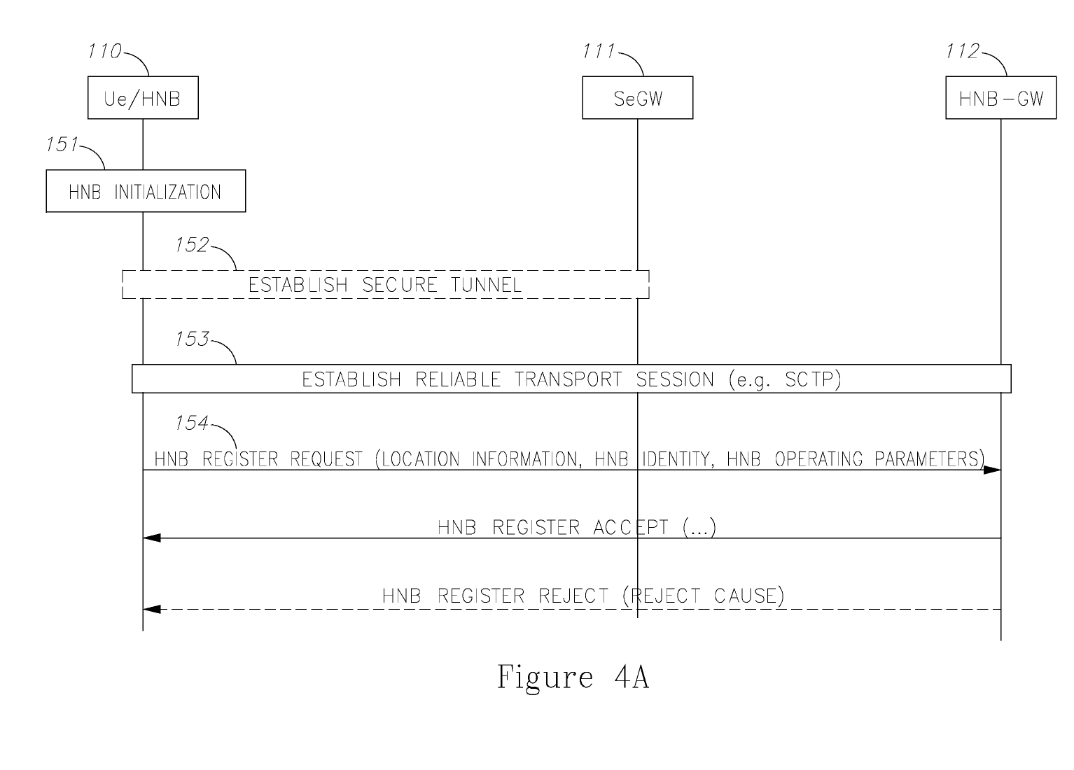

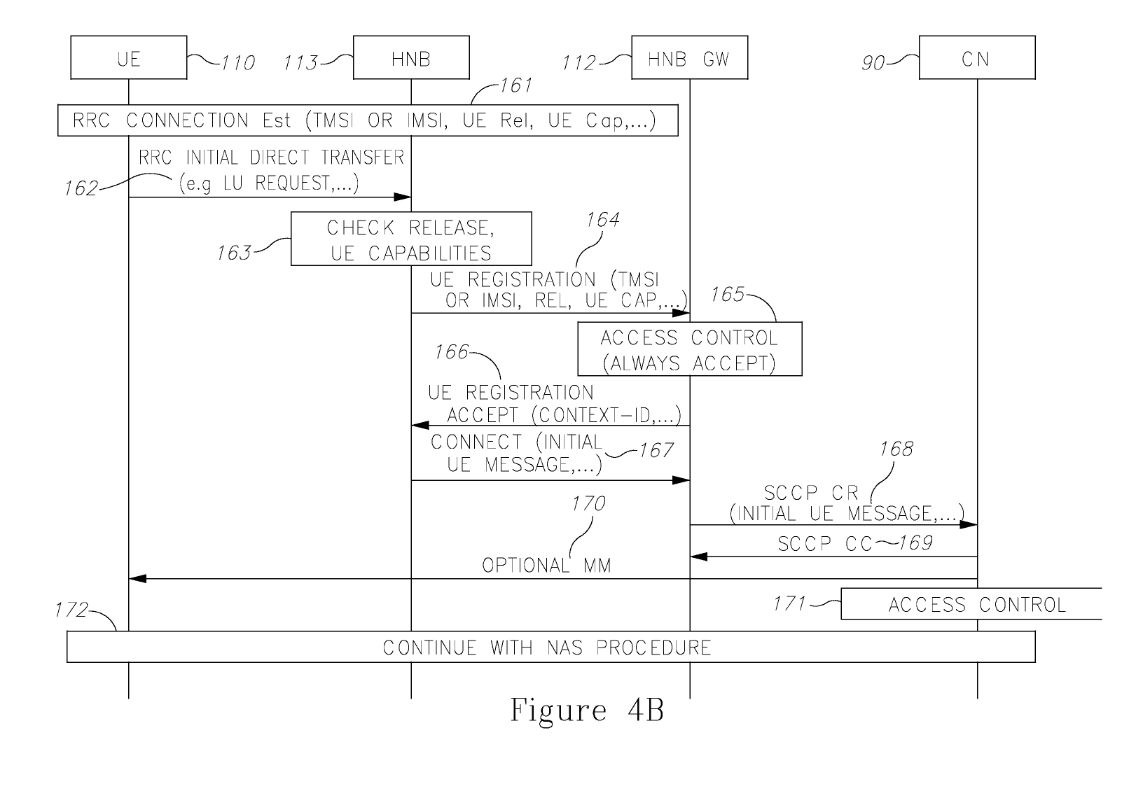

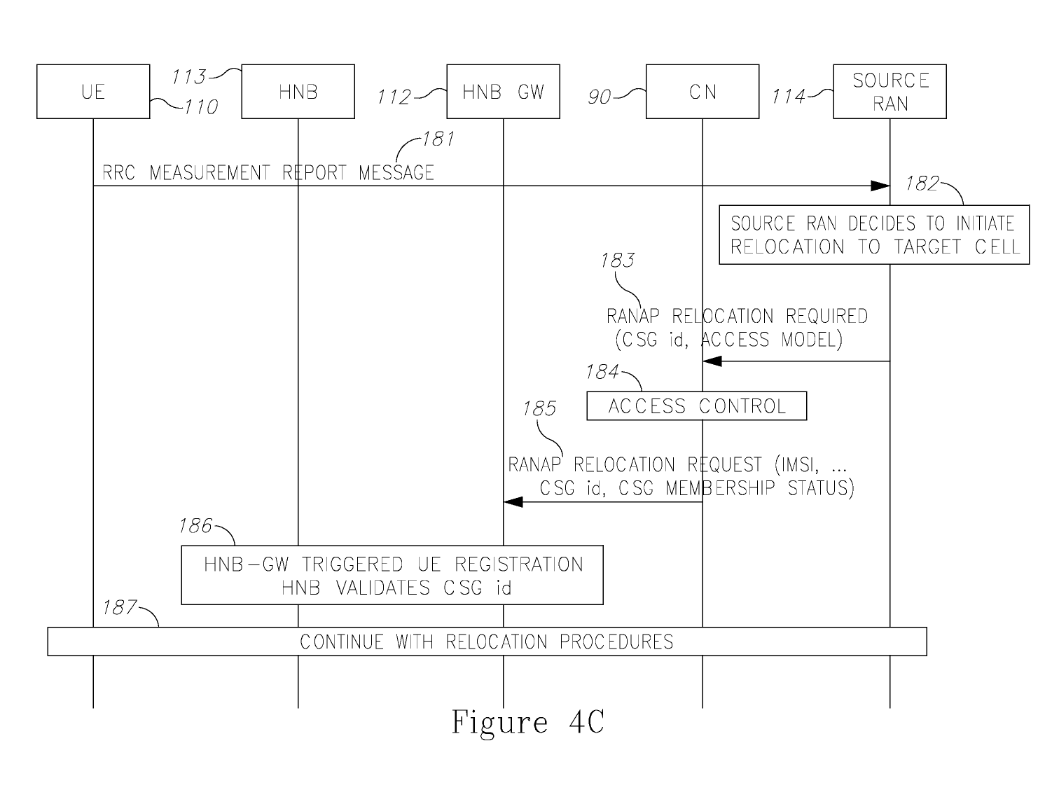

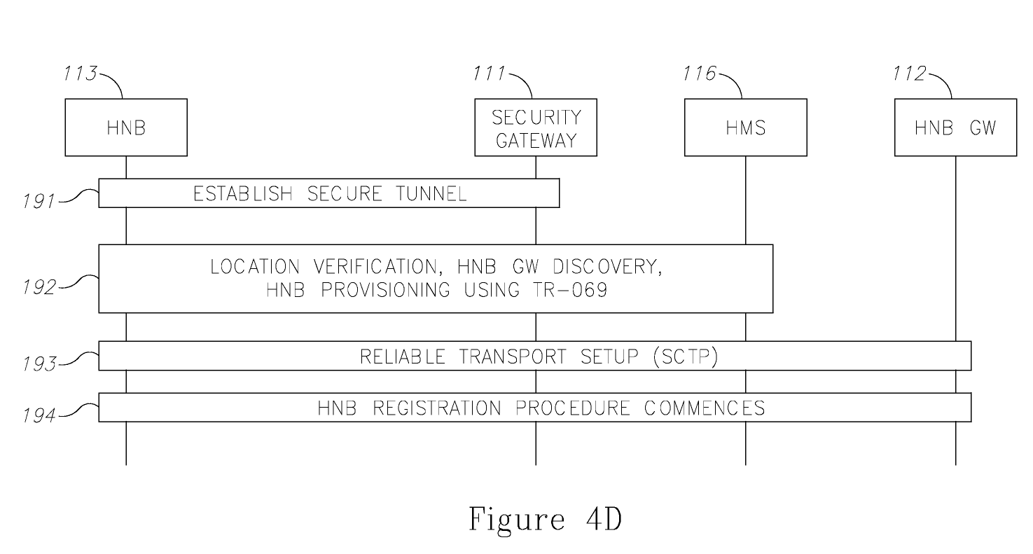

FIG. 4A is a high level illustration of the client HNB registration process, according to some embodiments of the invention. Controller 115 may perform Client HNB initialization (stage 151) to obtain HNB configuration from the client HNB Management System (HMS). Similarly, HNB Gateway (HNB-GW 112) discovery is performed to obtain the initial serving HNB-GW information.

The process comprises the following stages: (i) The client HNB establishes a secure tunnel to the Secure Gateway (SeGW 111) of the serving HNB-GW (stage 152). (ii) The client HNB sets up a reliable transport session, such as, an SCTP transport session to a well-defined port on the serving HNB-GW (stage 153). (iii) The client HNB then attempts to register with the serving HNB-GW using an HNB REGISTER REQUEST message (stage 154).

The message may contain Client HNB Location Information, Client HNB Identity (the client HNB has a globally unique and permanent identity), and Client HNB Operating Parameters (Such as the selected Location Area Code (LAC), Routing Area Identifier Code (RAC), Service Area Code (SAC), Public Land Mobile Network (PLMN) Id, Cell Id, etc.).

The client HNB provides location information via use of one or more of the following mechanisms: Detected macro-cell coverage information, e.g. GSM edge Radio Access Network (GERAN) and/or UMTS Terrestrial Radio Access Network (UTRAN) cell information; Geographical co-ordinates, e.g. via use of Global Positioning System (GPS), etc.; and Internet connectivity information (e.g. IP address), provided, the resulting location information is at least as accurate as location determination based on macro-cell coverage information, whether or not there is macro cell-coverage available at the location of the client HNB (e.g. as determined by point i above).

HNB-GW 112 may use the information from the HNB REGISTER REQUEST message to perform access control of the client HNB (e.g. whether a particular client HNB is allowed to operate in a given location, etc). If HNB-GW 112 accepts the registration attempt it shall respond with a HNB REGISTER ACCEPT message. If HNB-GW 112 has capability to de-multiplex, HNB-GW 112 may include a Multiplexer (MUX) port in the HNB REGISTER ACCEPT message. Alternatively, HNB-GW 112 may reject the registration request (e.g. due to network congestion, blacklisted client HNB, unauthorized client HNB location, etc). In this case, HNB-GW 112 shall respond with an HNB REGISTER REJECT indicating the reject cause.

FIG. 4B is a high level illustration of the client HNB registration process, according to some embodiments of the invention. Controller 115 may perform the client HNB registration process according to the following stages.

Upon camping on Wi-Fi access point 130, UE 110 initiates an initial Non Access Stratum (NAS) procedure (e.g. Location Update (LU) Procedure) by emulating a Radio Resource Control (RRC) connection with client HNB 113 (stage 161). UE identity and UE capabilities, e.g. “Access stratum release indicator” or “UE feature capability indicator”, are reported to client HNB 113 as part of the RRC Connection establishment procedure.

UE 110 then forwards to client HNB 113 an RRC Initial Direct Transfer message carrying the initial NAS message (e.g. Location Updating Request message) with some form of identity (e.g. IMSI or TMSI etc.) (stage 162).

Client HNB 113 checks the UE capabilities provided in stage 161 (stage 163), and if these indicate, for example, that Closed Subscriber Group (C5G) is supported and if the identity of UE 110 (provided during RRC Connection Establishment) is unknown, i.e. no Context id exist for UE 110, client HNB 113 initiates UE registration towards HNB-GW 112 (stages 164-166). If client HNB 113 has a context id for UE 110, UE registration procedure is not performed. No Identification procedure is triggered, independent of the identity reported by UE 110 during the RRC Connection Establishment.

Client HNB 113 attempts to register UE 110 on the HNB GW by transmitting the UE REGISTER REQUEST (stage 164). The message may contain: UE Identity: a unique identifier for UE 110 and provided in stage 161; UE capabilities: derived from that provided in stage 161; Registration Cause: the indication about a UE registration for an emergency call. NOTE: The UE IMSI/TMSI provided in the UE REGISTER message is unauthenticated.

HNB-GW 112 checks UE capabilities and if these indicate that CSG is supported and if client HNB 113 supports CSG, HNB-GW 112 shall accept the UE registration and allocate a context-id for UE 110 (stage 165).

HNB-GW 112 responds with a UE REGISTER ACCEPT message back to client HNB 113 including a context-id allocated to UE 110 (stage 166).

Client HNB 113 then sends a RUA CONNECT message containing the RANAP Initial UE message (stage 167). The RANAP Initial UE message may contain the Cell Access Mode.

The reception of the RUA CONNECT message at HNB-GW 112 triggers the setup of an SCCP connection by HNB-GW 112 towards Core Network 90 (CN) (stage 168). HNB-GW 112 then forwards the Initial UE Message including the CSG id of client HNB 113.

CN 90 responds with an SCCP Connection Confirm message (stage 169).

CN 90 may optionally perform Mobility Management procedures, e.g. Authentication procedure (stage 170).

CN 90 performs access control of UE 110 (stage 171).

After being granted access UE 110 then continues with the NAS procedure (e.g. Location Updating procedure) towards CN 90, via client HNB 113 and HNB-GW 112 (stage 172). During such procedures CN 90 may send to client HNB 113 the UE membership status for the accessed cell in the COMMON ID message.

FIG. 4C is a high level illustration of connect state 140C's hand-in mobility, according to some embodiments of the invention. Connect state 140C's hand-in mobility may be handled according to the following stages.

UE 110 may be triggered to send an RRC Measurement Report by the rules set by the UTRAN (stage 181). The Measurement Report includes the Cell Identity, CSG id (if requested) of target client HNB 113.

Source Radio Access network (RAN) node 114 makes a decision to relocate the UE session (stage 182).

Source RAN 114 triggers relocation of the UE session by sending the RANAP RELOCATION REQUIRED message to the Core Network (stage 183). The target RNC Id, CSG id. Target Cell Id and—for relocation to a hybrid cell -Cell Access Mode information along with relocation information are included by the source RAN in the RANAP RELOCATION REQUIRED message.

If the target cell, for example, is a CSG client HNB, the Core Network verifies that UE 110 is indeed a member of the CSG associated with the target cell, as reported to the Core Network [x1] (stage 184). Otherwise (if the target is a Hybrid Cell), the Core Network fills the CSG Membership Status IE in stage 185 to reflect UE 110's membership to the CSG.

HNB-GW 112 receives a RANAP RELOCATION REQUEST message from the Core Network, including the CSG id (stage 185). Target Cell Id and—for relocation to a hybrid cell—CSG Membership Status.

The stages for HNB-GW Triggered UE Registration are executed between HNB-GW 112 and client HNB 113 (stage 186). HNB-GW 112/HNB 113 validates the CSG id received in the RANAP RELOCATION REQUEST message.

The remainder of the relocation procedure continues normally as is defined by the 3GPP standard (stage 187).

Stages 182 to 187, as appropriate, are repeated for the second CN domain when present with the following exceptions. The relocation of the 2nd domain shall not trigger an additional registration. The 2nd RANAP Relocation Request shall be carried as RUA Direct Transfer. There is only one Context Id assigned to UE 110 regardless of the number of domains relocated from source RAN 114.

FIG. 4D is a high level illustration of the operation of client HNB 113, according to some embodiments of the invention. A secure tunnel is established from client HNB 113 to security gateway 111 (stage 191). Location verification is then performed by the HMS based on information sent by client HNB 113 (stage 192) (e.g. macro neighbor cell scans, global navigational satellite system type of information etc.). HMS (client HNB Management System 116, embodied e.g. in controller 115) determines the serving elements and provides HNB GW 112, HMS 116 and Security Gateway 111 to client HNB 113. HMS 116 also provisions configuration parameters to client HNB 113 only after successful location verification in HMS 116. For completeness reliable transport setup may then be performed (stage 193) and HNB registration procedure may commence (stage 194). Security gateway 111 and HMS 116 are shown to highlight the general architecture. In the event information required for verifying location are not available (for example, no macro neighbor cells, no GNSS, no DSL line ID etc. available), HNB GW discovery may be based on specific operator and/or regulatory policies.

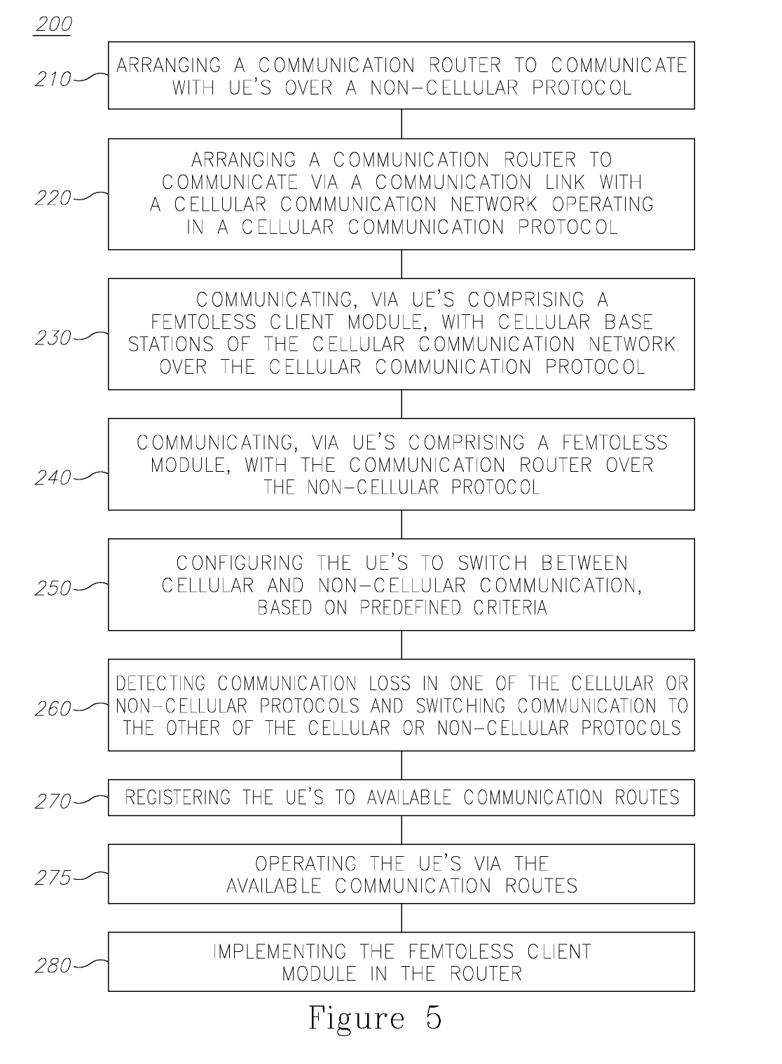

FIG. 5 is a high level schematic flowchart of a method 200, according to some embodiments of the invention.

Method 200 comprises the following stages, which were explained in further detail above: arranging a communication router to communicate with one or more user equipment (UEs) over a non-cellular protocol (stage 210) and further communicate via a wired communication link with a cellular communication network operating in a cellular communication protocol (stage 220); communicating, via the one or more UEs comprising a femtoless client module, with one or more cellular base stations connected to the cellular communication network over the cellular communication protocol (stage 230); and the communication router over the non-cellular protocol (stage 240); and configuring the UEs to switch between non-cellular and cellular communication, based on predefined criteria (stage 250).

Method 200 may further comprise detecting communication loss in one of the non-cellular and the cellular protocols and switching communication to the other of the non-cellular and the cellular protocols (stage 260), as well as registering the UE's to available communication routes (stage 270) and operating the UE's via the available communication routes (stage 275). Method 200 may further comprise implementing the femtoless client module in the communication router (stage 280).

In embodiments, some or all stages of method 200 may be implemented as a computer program product in either UEs 110 or router 130, or distributed among UEs 110 and router 130.

For example, embodiments comprise a computer program product comprising a computer readable storage medium having computer readable program embodied therewith, the computer readable program comprising: (i) computer readable program configured to communicate with one or more user equipment (UEs) over a non-cellular protocol and further communicate via a wired communication link with a cellular communication network operating in a cellular communication protocol; (ii) computer readable program configured to switch between non-cellular and cellular communication, based on predefined criteria; and (iii) computer readable program configured to communicate, via the one or more UEs with one or more cellular base stations connected to the cellular communication network over the cellular communication protocol; and with the communication router over the non-cellular protocol. The computer program product enables UE communication without cellular air interface.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Embodiments of the invention may include features from different embodiments disclosed above, and embodiments may incorporate elements from other embodiments disclosed above. The disclosure of elements of the invention in the context of a specific embodiment is not to be taken as limiting their used in the specific embodiment alone.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Different embodiments are disclosed herein. Features of certain embodiments may be combined with features of other embodiments; thus certain embodiments may be combinations of features of multiple embodiments.

Embodiments of the invention may include an article such as a computer or processor readable non-transitory storage medium, such as for example a memory, a disk drive, or a USB flash memory device encoding, including or storing instructions, e.g., computer-executable instructions, which when executed by a processor or controller, cause the processor or controller to carry out methods disclosed herein.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A system comprising:
a communication router arranged to communicate with one or more user equipments (UEs) over a non-cellular protocol and further communicate via a communication link with a cellular communication network operating in a cellular communication protocol; and
one or more UEs arranged to communicate with:
one or more cellular base stations connected to the cellular communication network over the cellular communication protocol; and
the communication router over the non-cellular protocol,
wherein the UEs are configured to switch between cellular and non-cellular communication protocols, based on predefined criteria.

2. The system of claim 1, wherein the UE's comprise a femtoless client module arranged to interface between the cellular and non-cellular protocols.

3. The system of claim 1, wherein the communication router comprises a femtoless client module arranged to interface between the cellular and non-cellular protocols.

4. The system of claim 1, wherein the UE's are further arranged to detect communication loss in one of the non-cellular and the cellular protocols and switch communication to the other of the non-cellular and the cellular protocols.

5. The system of claim 1, arranged to provide communication to the UE's via an available communication router using at least one of the non-cellular and the cellular protocols.

6. A method comprising:
arranging a communication router to communicate with one or more user equipment (UEs) over a non-cellular protocol and further communicate via a wired communication link with a cellular communication network operating in a cellular communication protocol;
configuring the UEs to switch between non-cellular and cellular communication, based on predefined criteria; and
communicating, via the one or more UEs with:
one or more cellular base stations connected to the cellular communication network over the cellular communication protocol; and
the communication router over the non-cellular protocol.

7. The method of claim 6, further comprising implementing a femtoless client module arranged to interface between the cellular and non-cellular protocols in the UEs.

8. The method of claim 6, further comprising implementing a femtoless client module arranged to interface between the cellular and non-cellular protocols in the communication router.

9. The method of claim 6, further comprising detecting communication loss in one of the non-cellular and the cellular protocols and switching communication to the other of the non-cellular and the cellular protocols.

10. The method of claim 6, further comprising registering the UE's to available communication routes and operating the UE's via the available communication routes.

11. A computer program product comprising a computer readable storage medium having computer readable program embodied therewith, the computer readable program comprising:
computer readable program configured to communicate with one or more user equipment (UEs) over a non-cellular protocol and further communicate via a wired communication link with a cellular communication network operating in a cellular communication protocol;
computer readable program configured to switch between non-cellular and cellular communication, based on predefined criteria; and
computer readable program configured to communicate, via the one or more UEs with one or more cellular base stations connected to the cellular communication network over the cellular communication protocol; and with the communication router over the non-cellular protocol.

12. The computer program product of claim 11, arrange to be implemented in the UEs.

13. The computer program product of claim 11, arrange to be implemented in the communication router.
